(19) United States
(12) Patent Application Publication
(10) Pub. No.: US 2002/0035551 A1
(43) Pub. Date: Mar. 21, 2002

(54) Method and system for oil and gas production information and management

(76) Inventors: Rodney D. Sherwin, Tulsa, OK (US); Raydon Mcdaniel, Carthage, TX (US); Ricky J. Dickerson, Whitehouse, TX (US)

Correspondence Address: HEAD, JOHNSON & KACHIGIAN, 228 W 17TH PLACE, TULSA, OK, 74119, US

(21) Appl. No.: 09/738,230

(22) Filed: Dec. 15, 2000

Related U.S. Application Data
(60) Provisional application No. 60/233,928, filed on Sep. 20, 2000.

(51) Int. Cl. G06F 17/60

(52) U.S. Cl. 705/412

(57) ABSTRACT

A system and method of managing and/or operating an oil and/or gas field including the steps of acquiring and processing information concerning oil and/or gas producing wells and/or oil field production transportation facilities and/or oil field production treatment facilities by providing signal generators each connected to respond to an item of oil and/or gas field equipment from which information is desired, transmitting signals from the signal generators to a data acquisition center, at the data acquisition center, deriving data from the signal generators and creating useful information, transmitting the useful information to operators and/or controllers in the oil and/or gas field for the control or operation thereof at the data acquisition center, creating information as to the status of the oil and/or gas field, and transmitting the information as to the status of the oil and/or gas field to authorized destinations requiring the information.

### REFERENCE TO PENDING APPLICATIONS

This application is related to Provisional Patent Application No. 60/233,928 filed on Aug. 9, 2000 and entitled “A Method and System For Oil and Gas Production Information and Management”.

### REFERENCE TO MICROFICHE APPENDIX

This application is not referenced in any microfiche appendix.

### SUMMARY OF THE INVENTION

The most common source of energy in the world today is petroleum hydrocarbons—that is, liquid hydrocarbons such as gasoline, kerosene, jet fuel, diesel fuel and so forth or gaseous hydrocarbons—that is, natural gas or liquified gas. Petroleum hydrocarbons are recovered from subterranean formations. The petroleum industry is concerned with exploring for, drilling, producing, transporting, storing, refining and marketing of hydrocarbon products. Most oil and gas wells are drilled in localized areas usually referred to as an oil or gas field. An oil or gas field may cover several square miles or many square miles and is characterized by well spacing. In the United States and many other areas of the world where the petroleum industry has been in existence for a number of years, oil and gas fields are fairly well defined and pipeline systems have been installed for gathering and transporting hydrocarbons, either as liquids or gases.

Natural gas is found in pressurized conditions in subterranean formations and flows to the earth's surfaces as a result of formation pressure. Liquid hydrocarbons may be found in pressurized formations but in many other formations the underground pressure is insufficient to force the liquid hydrocarbons—that is, crude oil, to the earth's surface and therefore the oil must be elevated to the earth's surface utilizing various kinds of pumping systems. After crude oil reaches the earth's surface it frequently must be treated to reduce water content, to remove excess salt content, to reduce hydrogen sulfide content, etc. or to separate out gas content before the crude oil is transported by pipelines to a location where it is refined into gasoline, diesel fuel, jet fuel, kerosene and many other highly useful and valuable derivative components. Gas must, in like manner, usually be treated from the point of the wellhead where it exits from the underground formation before it is ready to be distributed in pipelines to residences, commercial or industrial establishments for uses as a fuel. Gas typically must be treated and/or processed to remove poisonous gas, heavy hydrocarbon compounds, water and/or entrained free liquid hydrocarbons. Further, gas must then be compressed to cause it to flow efficiently through pipelines to the place of ultimate usage. For all these reasons operating an oil field, a gas field or a combination oil and gas field becomes a relatively complicated process. Oil and gas wells produce at varying rates and the rates for each well varies. For this reason it is important that operators have a way of gathering information as to the individual production of oil and gas wells. If a well is being pumped and the pumping mechanism becomes defective or inefficient, production can be dramatically effected and if the operator is not made aware of the production equipment failure within a reasonable time then substantial economic loss can occur.

Further most crude oil and natural gas in the United States, Canada and some other parts of the world are produced primarily on privately owned land. This requires accurate accounting of the interest between producers, royalty owners, and so forth so that the economic value of the production will be accurately distributed among a plurality of different interest.

Natural gas normally flows to the earth's surface under subterranean pressure but at the earth's surface must be compressed so that it can be moved efficiently through pipelines. Liquid products, such as crude oil, must be pumped to move them through pipelines, to storage facilities, and ultimately to refineries for processing. Producers need to know accurate flow rates of oil and gas at various stages in pipeline systems.

All of the above is to merely indicate that efficiently and effectively operating of an oil and/or gas field requires the continuous accumulation of substantial amounts of information and further, requires continuous decisions concerning the control of equipment. For this reason the effectiveness and efficiency of an information gathering system for use in making and implementing control decisions for the operation of an oil or gas field are very important in achieving maximum economic benefit.

The present invention is concerned with a method and a system for obtaining information and for management of an oil and/or gas producing field.

### BRIEF DESCRIPTION OF THE DRAWINGS

The drawing is a flow chart showing a schematic of the invention and a method of operation thereof for obtaining information and for management of an oil and/or gas field or fields.

### DETAILED DESCRIPTION OF THE PREFERRED EMBODIMENTS

The invention herein relates to a method and system for providing instantaneous flow of data from remote oil and gas field devices to an end user, typically an oil and/or natural gas producer. Automated data collection and monitoring provided by the system makes it possible for a user to grow gathering systems with a minimum of additional employees by allowing existing personnel to enhance their productivity using readily available sources of telemetry information. The primary focus of the system of this invention is to provide a means whereby well statistics, contractual expenses, divisions of interest, dynamic index pricing, spot and month-to-date flow volumes can be incorporated into a single data source and made available as a service to users via the Internet.

The interactive system of this invention allows customers to view current flow information on a single well or group of wells, apply contract and index pricing variables, and prepare a user configurable report ready for download. Data can be requested in mcf or mbtu values and viewed in tabular and/or graphical form. Information that in the past has been made available to interest owners 45 to 60 days following the end of a contract month can now, by the inventory herein, be made available at any time and is as close as the nearest web browser. Security is maintained by user name and password authentication and further determined by user profile.

In addition to revenue tracking services, the system also makes available operations web pages for the user. Pipeline graphics showing spot pressures and flows, month-to-date production reports, compression monitoring, plant monitoring, alarms and call-outs, well production rates or totals, dehydrator status, and tank battery automation status are examples of displays provided by the system.

The software components that are included in the system provide flexibility, expandability, configuration options, and compatibility and are used to make the most recent field information available on a real time basis. Data paths can be broken down into four categories, that is: a) remote data collection, b) field level utilization including editing of Electronic Flow Measurement (EFM) data, and storage, c) data transfer to a central office, and d) retrieval from related data sources, compilation, integration, and distribution to the Internet via the web server.

All communications with remote devices originate at one of the centralized host polling computers. These computers employ communications software drivers that support numerous protocols and serve as the “polling engine” to communicate with electronic flow measurement devices, compressor control panels, programmable logic controllers and so forth. The communication software supports serial as well as Internet Protocol connection to allow communication over any combination of the following paths: (a) spread spectrum radio; (b) cellular digital packetized data modems; (c) microwave; (d) Internet; (e) dial-up telephone; (f) dedicated data line (g) hardwire RS232 and 485; and (h) satellite.

One of the primary aspects of this invention and the methods employed, is the timely retrieval of the two types of data present in the individual flow meters. Electronic flow measurement data, defined as the time stamped hourly averages for pressure, differential, temperature, flow coefficient, flow time, flow/mcf, flow/mbtu, events and alarms, etc. is collected once daily for the previous 24 hourly averages. Instantaneous “spot readings” are requested several times daily. Update rates vary due to power restrictions on solar powered sites but are typically every 1 to 2 hours during the day. These values are time stamped, and include, current pressure, temperature, differential, flow/mcf, and flow/mbtu. Previous days flow, (contract hour yesterday through contract hour today), is also retrieved along with spot readings although the value will only change once per day.

Compressor and gathering stations are concerned with actual dynamic field operations and are polled as needed for critical control and monitoring. Typical update time is every 1 to 10 minutes. Faster update times can be selected for more critical operations. Processing and treating plants are scanned continuously with information updates based on delta change in the data point.

Electronic flow measurement data is collected once daily with each day's averages appended to those of the preceding days. In effect, a historical file is created for each meter. That file is a mirror image of the one contained in the meter. The historical file is stored on a polling computer until it is transferred, manually or automatically, over the network, to the import directory of the electronic flow measurement editor. Electronic flow meter files that will be processed by the customer are stored in separate folders where they are made available for download over the Internet or transferred via e-mail.

Commercially available software is utilized as the editor package for all electronic flow measurement data. Historical files can be imported at any time during the month for editing purposes or to prepare periodic gas volume statements. Commercial software is chosen for ease of use, troubleshooting features, report options, direct import of latest gas quality values and compatibility with the .cfx file format. Completed volume statements are printed by a network printer. Files for transfer over the network to a central office are provided.

All remote data is available for use in the area's field office and is utilized in a number of ways. Another commercially available software program is used to prepare graphic and schematic representations of individual well automation, pipeline, compressor stations, plant process controls, associated meter locations, etc. Actual real time input/output values are appended to background graphics. The result is a display that allows personnel a “snapshot” view of an entire gathering system's operating conditions.

In addition to the graphic capabilities, this commercial software also serves Microsof™ client applications such as Excel™ and Access™. Spread sheets with live data links are used to provide immediate report capabilities. Combined with time activated macros, the live data reports are used to prepare spreadsheets reflecting daily reading that result in monthly report summaries.

Alarm reporting is another aspect of the overall monitoring system incorporated in the remote data collection at the field office level. An additional commercially available software provides alarm notification. In addition to alerting “on-call personnel” to an alarm condition, the software also makes it possible for individuals to initiate a phone call to a subsystem and interrogate the sub-system for tagname values (monitored points in the system) that are available within specified call groups. Pressures, flows discrete values, etc. can be given in the form of voice synthesized messages.

Data storage at the field office is accomplished through the use of yet another commercially available software program and allows for faster retrieval of recently stored data. All points in the program are set up as “logged” tags and stored in either a delta change or timed basis. Any time a logged value changes, the new value is instantly stored. Query tools are utilized to access the information for trends and reports. It is possible to trend many months of archived data on a given point or group of points and have the most recent values drop in and become a part of the overall trend.

All field offices are linked with a home office via frame relay network. As a result, data can be passed between the offices with a high level of security. Copying files between any computer on the network is conveniently attainable. Gas volume statements and other reports are transferred in this manner. The real time data used to drive the system's web service utilizes the same network however the transfer occurs automatically and instantaneously.

The system is designed to support an unlimited number of individual tags and provides a rapid data retrieval rate. The system provides for multiple applications and is dynamically connected to live databases of the field applications. These connections are established over high speed links on the provider's wide area network. This system configuration insures that any tag value change at the field level is immediately stored in the control office server and is available for retrieval and distribution by way of the Internet.

All information regarding producers, interest owners, flow percentages, contracts, allocations, pricing etc. is stored in various databases in the central office and collectively referred to as corporate data warehouse. A commercially available software package serves to carry the diverse data sources and make them available in a user configurable form for presentation and distribution to the Internet.

Access to available system data is granted through a login and predefined user profile routine. User profiles are prepared in cooperation with the customer to include or deny varying levels of access to the data. Qualifying users in this manner makes it possible to segregate the information available to users with a given company.

Once a login is satisfied, available options are displayed on active menu buttons entitled: Summary, Spot, Volumes, Revenue, Contract, Pricing, and Contacts. Through these menu choices all relevant flow and pricing information is presented to the end user for evaluation.

The summary menu selection retrieves data on all accessible wells. This information includes: (a) well name and/or ID number; (b) revenue interest; (c) month-to-date flow in mcf; (d) month-to-date flow in mbtu; (e) net mcf and (f) BTU factor (British Termal Unit factor—that is, recoverable heat energy available).

In addition to the tabular data format, each well's month-to-date volume is represented in graphical form.

Data provided by the system gives a snapshot look at the latest request by a user for updated readings of a meter. These values are date and time stamped and include current values for: (a) pressure; (b) differential; (c) temperature; (d) mcf/flow; (e) mbtu/flow and (f) previous day's flow.

The volume menu selection of the system breaks out each individual well's flow for each month into daily increments. The volumes are given in mcf and mbtu values as well as the corresponding BTU factor. Geographic information such as the state, county, and field where the well is located is also included in this menu selection.

The revenue selection provided by the system allows a user to get an up to the minute estimate of the expected revenue on a given well or group of wells. The month-to-date mmbtu volume, current price index, and associated fees are factored into the calculations.

The system provides a contract menu button to allow a customer to view pertinent contract information and review applicable fees. Components included in this selection include: (a) contract reference number, contract date, effective date, and rotation; (b) gathering and compression fees and (c) contract pressure limitations.

A pricing menu selection gives the user the most up-to-date price index of the major pipelines in a relevant geographic region of any selected well.

The system includes a contacts button that provides a means for a user to let the central office know of any questions, concerns or requests the user may have with regards to the system.

The method and system for oil and gas production information and management as described herein is an Internet-based telecommunications service for a complete range of data gathering, production reporting, monthly and daily financial statements, process and equipment monitoring and facility control applications for owners and operators of oil and/or gas producing, transporting and/or storage properties and provides a market-based network that lets users access information they need immediately. By the system and method of this invention, users are saved the trouble of building and operating their own area networks.

The system herein is modular and designed and based on software architecture that is readily upgraded as new technology is developed and made available. Therefore, the user always enjoys service from a system operating on the latest available technology. The Internet connectivity makes the system easy and cost-effective to integrate into users existing proprietary systems and provides information in a format that flows directly to the users own network.

Field data is made immediately and continuously available to every customer via the customer's own web browsers employing their own PCs.

The system reduces the overhead by eliminating manpower and vehicles needed to cover the operation of multiple field locations. Additionally, digital transfer of data for financial statements and operational reports directly to users simplifies accounting procedures and eliminates data entry requirements.

The systems telecommunications database stores each users data separately and acts as a data warehouse for information retrieval. The system employs graphic display software where helpful to enable customers to see monitoring and control systems through process flow diagrams. Additionally, production trends, production analysis graphs, and financial graphs are made available so that the user can fully evaluate his energy stream.

The real-time Internet based production, reporting and management system described herein employs remote communication devices including electronic flow meters, chromatographs, programmable logic controllers, distributive control system and supervisory control and data acquisition field input devices. The system makes use of area communications systems accomplished by microwave, spread spectrum radio, cellular digital packetized data, the Internet, dial-up phone connections, hardwire 232/485, dedicated data lines, satellite and combinations of the above.

The system includes regional control networks that typically contain the following subsystems: (a) lab chromatograph server; (b) electronic flow meter evaluation/editor servers; (c) remote data acquisition servers; (d) regional data source manager servers; and (e) plant distributive control system servers.

Lab chromatographs provide compositional analysis of gas and liquid products and produce reports which are pushed directly in the information and management system.

Electronic flow meter evaluation/editor measurement analysis edits and monitors data utilizing advanced software and flags problems not seen in day-to-day operations.

Remote data acquisition servers handle seven day per week, 24 hours per day collection of data and provide supervisory control and monitoring that triggers alarm notifications and call-outs as required. These servers accommodate phone call in for synthesized voice production reports and alarm status.

Plant distributive control system servers provide 24 hour per day control and monitoring for processing and treating plants. Regional data source manager collects and manages data from the remote data acquisition server, the plant distributive control system server and electronic flow meter evaluation server 24 hours per day.

The oil and gas production and management systems include a national service center that contains four sub-systems: (a) national data source manager server; (b) an Internet access server; (c) a corporate data warehouse server and (d) a national control manager. The national service center receives and manages data from regional remote data acquisition servers, stores and formats it to customers requirements, then forwards it immediately to the customers. Dynamic supervisory control and data acquisition is performed in parallel operation with the regional remote data acquisition servers.

The national data source manager server manages, collects, and stores live real time data seven days a week, twenty-four hours per day from the regional remote data acquisition servers. The Internet access server formats data from the national data source manager as required for each customer's production reports, financial statements, trending and graphs and then transmits reports, graphs, trend analysis, supervisory control, monitoring, alarm reports and settlement statements to customer via Internet or e-mail. The corporate data warehouse server compiles contract briefs for customer settlement statements, collects and manages index prices of respective commodities, and pushes information to the Internet access servers for formatting. The national control manager provides dynamic supervisory control and monitoring in parallel operations with the regional remote data acquisitions server. Sophisticated graphical display software provides detailed process flow diagrams for visualizing and developing real-time pictures for monitoring and controlling each system.

The modular design of the system described herein provides a customized service to fit each customer's need. Supervisory control and data acquisition is provided for each customer's gathering systems, compressor station, dehydration sites, liquid handling facilities, processing and treating plants or any other type of facilities. Each customer retains the option to pick and choose the level of service the customer wants from simple wellhead electronic flow meter monitoring to complete supervisory control and data acquisition of the customer's entire oil and gas production system.

The system provides customized, menu-based reports for each client consisting of menu buttons: (a) summary; (b) spot; (c) volume; (d) revenue; (e) contract; (f) pricing; (g) settlement and (h) contacts. Reports can be structured to any format the customer desires. Different levels of security can be implemented in order to allow customers to decide who can access specific information.

The oil and gas productions management system of this invention provides to each customer periodic summaries that contain month-to-date information for each well or central delivery point all on one page. Each summary typically contains: (a) well or central delivery point identification number; (b) well or central delivery point name; (c) total month-to-date flow; (d) BTU factor; (e) royalty interest ownership; (f) royalty interest month-to-date flow in mcf; (g) royalty interest month-to-date flow in mbtu; (h) month-to-date gross revenue; and (i) all data is shown in graphical format also.

The system described herein also provides snapshots of the latest data for each well or central delivery point on an individual basis. Each snapshot report typically displays: (a) system or well operating pressure; (b) orifice differential pressure in inches of water; (c) operating temperature; (d) flow in mcfd; (e) flow in mbtu; (f) previous day's flow in mcfd; and (g) previous day's flow in mbtu.

The system can, at the option of each customer, provide individual well or central delivery point volume data reports on a daily basis for each day of the month. These volume reports can include geographic information, state, county and field breakdowns. The system can provide month to date estimated revenue for each of a customer well central delivery points or processing agreements based on daily information. Month-to-date mmbtu, current index pricing for natural gas, NGL liquids, condensate and oil, along with the gathering or processing agreement are employed in determining the customer's daily revenue. A unique feature of the oil and gas production information and management system of this invention is that it can provide, an individualized look and feel for each customer.

Other relevant information that can furnish customers that can be furnished to customers who utilize the services available from the methods and system of this invention include: (a) up-to-date price increase on pertinent commodities; (b) monthly settlement statements; and (c) direct e-mail connection to management system personnel to answer questions, concerns or requests.

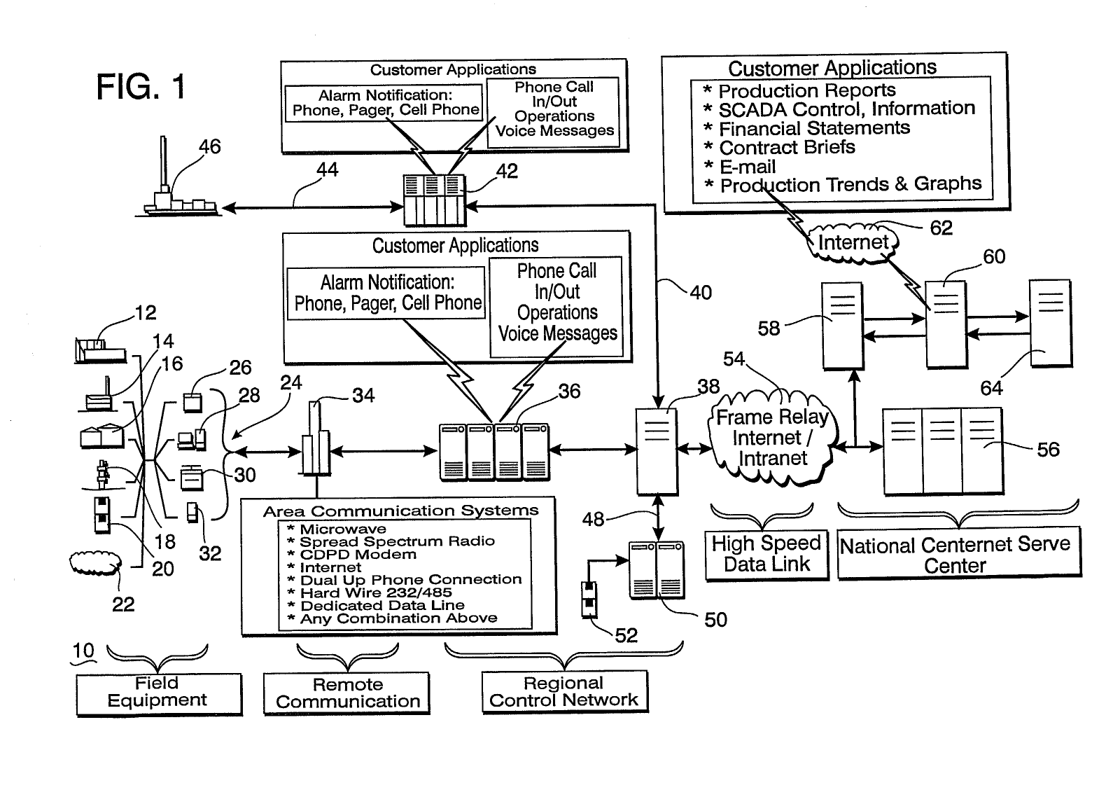

Referring to the drawing, a typical block diagram is illustrative of one system that can be used for practicing the methods of this invention, the drawing serving to illustrate the services that can be provided to a customer. The drawing illustrates an example of services for a single customer with the understanding that the system will typically be simultaneously employed for a plurality, and even a large number of separate and distinct customers. The system illustrated in the drawing serves an oil and gas producing field that may cover a relatively small area such as a single gas producing plant or a small oil field having a few wells or that can include hundreds of oil and/or gas wells, compressor stations, oil and gas processing and treating facilities, pumping stations, wellheads, pipelines and so forth. Whether a small or large field, the customer's equipment is monitored electronically as identified by “Field Equipment” and by the numeral 10. Field equipment can include equipment for measuring physical perimeters at a large number of different types of field installations. In FIG. 1, these field installations can include, by way of example, compressor stations 12; dehydration sites 14—that is, sites where water can be removed from crude oil or natural gas; liquid handling facilities 16 which can include storage tanks, underground gas storage facilities and so forth; wellheads 18—that is, the equivalent where natural gas and/or crude oil arrives from an underground formation to the earth's surface and where facilities are provided for transporting such natural gas and/or crude oil to storage and/or treatment so that ultimately such natural gas or crude oil is delivered to a refinery in the case of crude oil, or to gas storage facilities and subsequently to pipelines for delivery to homes, commercial establishments, factories, and so forth; chromatographs 20—that is, equipment that practices chromatography that functions essentially by separating mixed substances by passing the mixed substances through or over absorbing materials (chromatographs are particularly valuable in measuring the relative content of a natural gas stream to thereby establish the proportions of different components of the gas mixture) and other physical equipment 22 can include such apparatus and systems to reduce the viscosity of crude oil to improve the flow rate and so forth.

The areas measurements that are required to provide information as to the condition and performance of the multitude of different pieces of equipment and systems that are necessary for commercially producing oil and gas fields include apparatus and system for converting measurements to electrical signals. This type of equipment is generally identified as “remote communication” and generally identified by the numeral 24. Such remote communication equipment can be such as illustrated—that is, electronic flow measurement equipment (EFMs 26); programmable logic controllers (PLCs 28); remote transmitting units (RTUs 30) and distributive control systems (DCS 32).

Information that is gathered by the field equipment 10 is converted into electrical signals by remote communication equipment 24 and is fed by an area communications system 34 to a remote data acquisition center 36. The area communication systems may include microwave, spread spectrum radio, cellular digit packet data (CDPD) modems, Internet, dial-up phone connection, hard wire 232/485, dedicated data line, or any combinations of the above. In short, the area communication system can be inclusive of any type of system whether in use today or that is devised in the future that can transmit data generated by the remote communication devices 24 to a remote data acquisition server 36. As a consequence of the data received at the remote acquision server 36, various messages and other forms of information can be generated and transmitted directly to a customer for the benefit of a customer. These messages and/or benefits can include alarm notification by telephone, pager, cell phone or so forth or direct phone calls to customers for the delivery of voice messages.

Data from remote data acquisition server 36 is passed to a regional data source manager 38, a piece of equipment that functions to divide information signals for delivery to a plurality of locations and for receiving data from a plurality of locations that in turn is fed to remote data acquisition server 36.

From the information that is generated at the remote data acquisition server 36 and passed to the regional data resource manager 38, instructions can be distributed as indicated by line 40 to a plant distributor control system server 42. Server 42 can route information to a customer such as alarm notification by phone, pager, cell phone, etc. or transmit messages by voice directly by way of telephone to a customer representative. Further, the plant distributive control system server 42 can provide signal outputs by line 44 to processing and treating plants indicated by the numeral 46. The signal provided on line 44 to processing and treating plants 46 can, for instance, be employed to shut down plants when necessary, speed up or slow down the action of pumps to increase or decrease volume or pressure or take any other actions that are required or beneficial for the operation of a processing and/or treating plant.

Information from the regional data source manager 38 can be transferred as indicated by line 48 to an electronic flow measurement evaluation/editor 50 that provides evaluation reports, summaries and so forth. Electronic flow measurement evaluation/editor 50 also provides permanent records required of the system. These permanent records can be delivered to the customer as a back up to the electronic information that is transmitted to the customer more or less on a continuous basis. In the evaluation/editor function of the electronic flow measurement equipment 50 a lab chromatograph 52 may be employed.

Information from the regional data source manager 38 is transmitted over the frame relay network or the Internet as indicated by the numeral 54 although the transmission could be by telephone, including hard wired or cellular phone systems including satellite telephone communication systems so that in any event, the information from regional data source manager 38 is transmitted concurrently to a national control manager 56 and simultaneously to a national data source manager server 58. Server 58 supplies information to Internet access server 60 that can transmit information for a customer's application, such as production reports, supervisory control and data acquisition control (SCADA) information, financial statements, contract briefs, e-mail, production trends and graphs and so forth. The information transmitted to Internet access server 60 can also, as indicated, be passed to a corporate date warehouse server 64 where a customer's permanent data can be maintained either electronically or electronically in combination with hard copies.

The method and system for oil and gas production information and management has been described herein and as illustrated in one embodiment on the drawing, is intended to take full advantage of the vast array of communication opportunities afforded by the Internet system. By making full use of the Internet, maximum information can be transmitted and utilized by the maximum number of facilities at a minimum cost. By effectively utilizing the opportunities made available by the Internet, oil and gas production information and management can be more economically acquired and utilized than has been possible in the past.

The claims and the specification describe the invention presented and the terms that are employed in the claims draw their meaning from the use of such terms in the specification. The same terms employed in the prior art may be broader in meaning than specifically employed herein. Whenever there is a question between the broader definition of such terms used in the prior art and the more specific use of the terms herein, the more specific meaning is meant.

While the invention has been described with a certain degree of particularity, it is manifest that many changes maybe made in the details of construction and the arrangement of components without departing from the spirit and scope of this disclosure. It is understood that the invention is not limited to the embodiments set forth herein for purposes of exemplification, but is to be limited only by the scope of the attached claim or claims, including the full range of equivalency to which each element thereof is entitled.

What is claimed:

1. A system for acquiring and processing information from a plurality of oil and/or gas producing wells and/or oil field production transportation facilities and/or oil field production treatment facilities, comprising:
a plurality of signal generators, each signal generator being associated with an item of equipment from which information is desired;
an area communication system connected to receive signals generated by said signal generators and for transmitting signals to at least one remote location;
a remote data acquisition center and server connected to said area communication system for receiving signals generated by said signal generators and for creating derived information; and
a regional data source manager system connected to receive said derived information from said remote data acquisition center and for distributing said derived information to customer applications and/or data links.

2. A system according to claim 1 wherein said derived information is distributed by said regional data source manager by means of the Internet.

3. A system according to claim 1 wherein said signal generators function to generate signals from at least one of the following:
a compression station, a dehydration site, a liquid handling facility, a wellhead, a chromatograph and a flow enhancement facility.

4. A system according to claim 1 wherein said generators are selected from electronic flow measurement devices, programable logic controllers, remote transmitting units and distribution control systems.

5. A system according to claim 1 wherein said regional data source manager includes at least one sub-system selected from:
(a) a lab chromatograph server; (b) an electronic flow meter evaluation/editor server; (c) a remote data acquisition server; (d) a regional data source manager server; and (e) a plant distributive central system server.

6. A system according to claim 1 including a national service center connected to receive distribution from said regional data source manager.

7. A system according to claim 6 wherein said national service center includes one or more sub-systems selected from:
(a) a national data source manager server; (b) an Internet access server; (c) a corporate data warehouse server; and (d) a national control manager.

8. A system according to claim 6 wherein said national service center provides customized menu-based reports for clients selected from one or more menu buttons comprising:
(a) summary; (b) spot; (c) volumn; (d) revenue; (e) contract; (f) pricing; (g) settlement; and (h) contracts.

9. A system according to claim 6 wherein said national service center provides periodic summaries wherein each summary contains one or more of:
(a) a well or central delivery point identification number; (b) a well or central delivery point name; (c) the total month-to-date flow of a selected well or delivery point; (d) a selectable BTU factor report; (e) a royalty interest ownership report; (f) a royalty interest month-to-date flow report; (g) a month-to-date gross revenue report; and (h) a graphical display of any or all of each such summary.

10. A method of managing and/or operating an oil and/or gas field or fields comprising the steps of:
(a) acquiring and processing information concerning a plurality of oil and/or gas producing wells and/or a plurality of oil field production transportation facilities and/or a plurality of oil field production treatment facilities by providing a plurality of signal generators each connected to respond to an item of oil and/or gas field equipment from which information is desired;
(b) transmitting signals from at least some of said signal generators to a remote data acquisition center;
(c) at said data acquisition center, deriving data from said signal generators and creating useful information;
(d) transmitting said useful information to operators and/or controllers in said oil and/or gas field or fields for the control or operation thereof;
(e) at said data acquisition center, creating information as to the status of said oil and/or gas field or fields; and
(f) transmitting said information as to the status of said oil and/or gas field or fields to authorized destinations requiring and/or desiring said information.

11. The method of claim 10 wherein step (f) is transmitted by use of the Internet.
